(19) United States
(12) Patent Application Publication
(10) Pub. No.: US 2011/0258192 A1
(43) Pub. Date: Oct. 20, 2011

(54) PROVIDING QUESTION AND ANSWER SERVICES

(75) Inventors: Jun Yao, Beijing (CN); Jinhui Du, Beijing (CN)

(73) Assignee: GOOGLE INC., Mountain View, CA (US)

(21) Appl. No.: 12/955,615

(22) Filed: Nov. 29, 2010

(30) Foreign Application Priority Data
Apr. 15, 2010 (CN) PCT/CN2010/071808

(51) Int. Cl. G06F 17/30

(52) U.S. Cl. 707/737; 707/E17.046

(57) ABSTRACT

Methods, systems, and apparatus, including computer programs encoded on a computer storage medium, for question and answer services. In one aspect, a method combines receiving a plurality of questions from a plurality of different servers according to a protocol that defines services for submitting questions and obtaining answers to questions. Each received question is analyzed and associated with one or more labels based on the analysis. A request from a server is received according to the protocol to obtain questions related to one or more labels. Questions associated with one or more of the labels are identified and provided in response to the request.

### CROSS-REFERENCE TO RELATED APPLICATIONS

Under 35 U.S.C. §119(a), this application claims benefit of Patent Cooperation Treaty Application No. PCT/CN2010/071808, filed Apr. 15, 2010, the entire contents of which is hereby incorporated by reference.

### TECHNICAL FIELD

This specification relates to digital data processing and, in particular, question and answer services.

### BACKGROUND

A computer-based communication network system can include a network of computers to enable communications. A communication network system can be a single computer network such as a computer network within an enterprise or a network of interconnected computer networks such as the Internet. Various services can be provided via such a communication network. For example, Question and Answer (Q&A) services allow Internet users to post questions on a website or forum so that other users can provide answers to the posted questions.

### SUMMARY

In general, one innovative aspect of the subject matter described in this specification can be embodied in methods that include the actions of receiving a plurality of questions from a plurality of different servers according to a protocol that defines services for submitting questions and obtaining answers to questions; for each received question, analyzing a textual form of the question and associating the question with one or more labels based on the analysis; receiving a request from a server according to the protocol to obtain questions related to one or more first labels; and identifying questions associated with one or more of the first labels and providing the identified questions in response to the request. Other embodiments of this aspect include corresponding systems, apparatus, and computer programs, configured to perform the actions of the methods, encoded on computer storage devices.

These and other embodiments can each optionally include one or more of the following features. Analyzing the textual form of the question and associating the question with one or more labels comprises using a concept graph to determine the labels based on words in the textual form of the question. The protocol can define services for one or more of: creating, getting, searching, deleting, closing, labeling, forwarding, suggesting, classifying or rating a question. The protocol can define services for one or more of: creating, labeling, rating, feeding, threading, getting or deleting an answer. The protocol can be defined in Extensible Markup Language. The protocol can be defined in Java Script Object Notation. A first question in the plurality of questions was submitted by a user using an interactive gadget.

Particular embodiments of the subject matter described in this specification can be implemented so as to realize one or more of the following advantages. A common application programming interface (API) is provided that can be used by different providers of Q&A services. As a result, a single user logon can be used for different Q&A service providers. The API also allows providers of Q&A services to exchange questions and answers. The Q&A services accessible through the API can implement functionality for creating, getting, searching, deleting, closing, labeling, forwarding, suggesting, classifying or rating the questions, creating, labeling, rating, feeding, threading, getting or deleting the answers, creating, identifying or ranking the users of Q&A services. Users can post questions using gadgets which provide a convenient graphical user interface for the API.

The details of one or more embodiments of the subject matter described in this specification are set forth in the accompanying drawings and the description below. Other features, aspects, and advantages of the subject matter will become apparent from the description, the drawings, and the claims.

### DESCRIPTION OF THE DRAWINGS

FIG. 1 illustrates an example of a communication system for providing Q&A services.

FIG. 2 is a flow diagram illustrating an example of a method for providing Q&A services.

FIG. 3 is a flow diagram illustrating another example of a method for providing Q&A services.

FIG. 4 is a block diagram illustrating an example of a system for providing Q&A services.

FIG. 5 is a block diagram of an apparatus for providing Q&A services.

Like reference symbols in the various drawings indicate like elements.

### DETAILED DESCRIPTION

Systems, devices and techniques described in this specification can be implemented in ways to provide a common Application Programming Interface (API) to enable communications between different processes to enable Q&A services. This common API provides a language and platform neutral protocol to facilitate the communications of Q&A services including communications between different web sites.

In some implementations, common APIs can be used to allow different websites (or “clients”) to access Q&A services provided by a service provider. APIs include operation instructions regarding Q&A services such that the service provider can perform Q&A service request based on the operation instructions. In some implementations, at least one of the websites can request to issue the questions to the service provider and, as a response, the service provider can receive and further process such questions. In some implementations, at least one of the websites can request to retrieve relevant questions from the service provider and, as a response, the service provider can provide the relevant questions thereto.

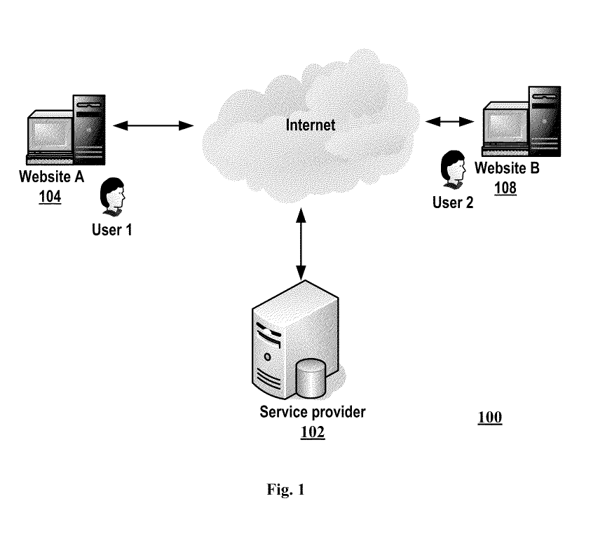

FIG. 1 exemplarily illustrates a simplified diagram of a communication system 100 for providing Q&A services. In FIG. 1, shown in the system 100 are two websites: website A 104 and its user 1, website B 108 and its user 2, and a service provider 102. Websites A 104, B 108 and the service provider 102 can communicatively couple to each other by an external network (e.g., Internet) through common communication protocols, e.g., Transmission Control Protocol/Internet Protocol (TCP/IP). A service provider can be embodied in various ways, such as a network server, an array of servers, a large-scale data processing or computing apparatus or the like. In addition, although two websites are shown herein, three or more websites can communicatively couple to the service provider dependent on the processing capacity of the service provider.

In one implementation, the service provider 102 can predefine a plurality of APIs with respect to Q&A services and then provide them to the plurality of the websites, such as websites A 104 and B 108 in FIG. 1. APIs are in accordance with Extensible Markup Language (XML) format or Java Script Object Notation (JSON) format, for example. Other formats are possible. From an economic standpoint, the forgoing providing APIs may be based on a contract or an agreement between the websites and the service provider. As such, websites A 104 and B 108 as shown in FIG. 1 could be partners of the service provider and thus have right to obtain such APIs from the service provider. From a technical standpoint, the service provider can send APIs to cooperative websites directly. Upon receipt of APIs, websites A 104 and B 108 may use them to access Q&A services provided by the service providers.

By way of illustration, APIs being in accordance with the JSON format will be illustratively described. With respect to a plurality of Q&A operations that generally occur during the interaction between the websites and service provider, a plurality of APIs can be provided to include operation instructions regarding Q&A services. For example, regarding the questions, APIs may be defined for the operation instructions of creating, getting, searching, deleting, closing, labeling, forwarding, suggesting, classifying or rating the questions. Take the operation instruction of creating a question as example, the illustrative API is coded as follows.

Creating one question at the service provider

request: {
“method” : “topic.create”,
“params”: {
“topic”: {
“subject”: “Why is the sky blue”,
“detail”: “Please explain in more detail”,
“labels”: [“physics”, “sky”], “userId”: “123456”,
“appData”: {“point”: 10}
}
}
}

When the websites, such as websites A 104 or B 108, use the forgoing API to initiate a request to create one question, such as the subject “Why is the sky blue” as above, at the service provider, the service provider may accept and parse such request so as to obtain the question data carried by the API. Next, the service provider may optionally perform further processing on the question, such as authenticating, storing, labeling, and indexing or the like.

In some implementations, labels for a subject or question can be determined automatically using a concept graph. Nodes of a concept graph represent concepts and edges in the graph represent relationships between the concepts. A concept graph can be constructed in various ways. For example, a data set such as a corpus of documents can be separated into clusters in which each cluster represents documents with similar characteristics using an expectation-maximization (EM) clustering algorithm. A vector of terms or words can be generated for each cluster that contain words representing concepts for that cluster. Terms or words in the question can be used to find related concepts in the concept graph that can serve as labels for the question. For example, the question “Are apples reliable computers?” is related to the concept of Apple the computer, instead of apple the vegetable, because the word “apples” is modified by the word “computers”.

Finally, as a result of successfully creating the question, the service provider can also return a reply to website by API as below.

reply:{
“result”: {
“topicId”: “abc123”
“state”: “NORMAL”
}
}

That is, the service provider uses “topicId” (the identity of the question) and “state” as a response to the creation of the question.

Likewise, regarding the answers, APIs can also be defined for the operation instructions of creating, labeling, rating (evaluating the answer), feeding (collecting a plurality of similar answers to one question), threading (getting the questions and answers together), getting or deleting the answers. Regarding the users, APIs can also be defined for the operation instructions of creating, identifying or ranking the users of Q&A services. For further illustrating the present technique, the API regarding the operation instructions of creating one answer and getting users of Q&A services and their reply are shown as below, respectively.

Creating one answer at the service provider:

request:{
“method” : “followup.create”,
“params”: {
“followup”: {
“topicId”: “123”,
“detail”: “This the content.”,
“timestamp”: 1251785927000,
“userId”: “123456”
}
}
}
reply: {
“result”: {
“followupId”: “abc”,
“state”: “NORMAL”
}
}
Getting users at the service provider:
request: {
“method”:“user.get”,
“params”:{
“userIds”: [“1”,“2”,“3”,“4”,“5”,“7”] }
}
reply: {
“result”:{
“users”:[<USER1>, <USER2>, ]
}

It should be understood that the forgoing coding of APIs are only illustrative and for conciseness, some object element definitions, such as type, optional item, default item and description are omitted herein. Additional information regarding exemplary implementations of APIs in the JSON API format is provided in Section entitled “Q&A JSON API” of this specification. Other API codes may also be used. In addition to the JSON API format used herein, other API formats, such as the XML API format, may also be used for APIs.

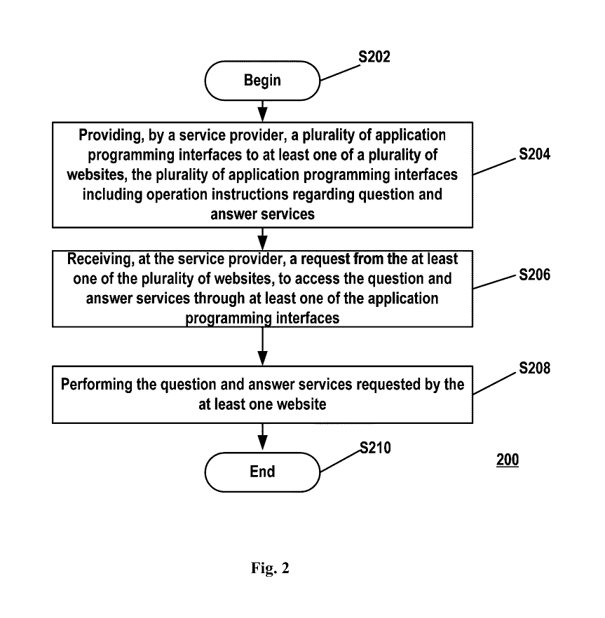

FIG. 2 is a flow diagram illustrating a method for providing Q&A services. As illustrated in FIG. 2, the method 200 begins at step S202 and provides, by a service provider, a plurality of APIs to at least one of a plurality of websites (e.g., website A 104 or B 108 as shown in FIG. 1) at step S204. The plurality of APIs include operation instructions regarding Q&A services. In one embodiment, the operation instructions regarding Q&A services comprise at least one of creating, getting, searching, deleting, closing, labeling, forwarding, suggesting, classifying or rating the questions, creating, labeling, rating, feeding, threading, getting or deleting the answers, creating, identifying or ranking users of Q&A services receiving. At step S206, the method 200 receives at the service provider, a request from the at least one of the plurality of websites, to access Q&A services through at least one of APIs. Then the method 200 proceeds to step S208. At step S208, the method 200 performs the Q&A services requested by the at least one website. Finally, the method 200 ends at step S210.

Q&A services can be accessed through APIs under different implementing scenarios based on the different context.

For example, suppose that website A 104 is a vertical website that provides professional Q&A services, such as medical or tourist Q&A services, and has many professional personnel who can provide expert opinion. However, due to low visit volume or popularity, website A 104 does not have many questions to be answered by the professional personnel; thus it may result in the waste of labor cost. Website A 104 may request the questions from the service provider using API including the operation instruction for getting questions. Upon receipt of such request, the service provider can authenticate website A 104 by way of 2-legged OAuth authentication, as a non-limiting example. Subsequent to the authentication, the service provider can provide the relevant questions to website A 104. The relevant questions may be such questions that have certain keywords or labels (i.e., questions having certain characteristic) desirable for website A 104. For example, a question, such as “How old is the earth”, is labeled as a physical question and indicated by indicative bits “001” (dedicated to refer to physical questions), then websites being expert in physics prefer to obtain such kind of question having indicative bits “001.”

Likewise, after website A 104 finished answering the questions, it may again request to create answers at the service provider by way of APIs. From the service provider standpoint, it will receive a request to create the answer from website A 104 and create the answer thereon. Then, the service provider may perform the threading, feeding, or the similar operation as required. In such a way, from the user point of view, the questions issued on website A 104 can be answered by the user of website B 108 (or a plurality of other websites). Thereby, what the user needed is to post the question only once on one website and obtain a plurality of answers from a plurality of other website (even may include professional websites) without repeating the posting operation.

With the method as shown in the above embodiment, different Q&A services provider may share question and answer contents through APIs and the Q&A contents may be utilized more efficiently.

Since it is possible that different Q&A services provider may share Q&A content, the procedure that a user posts the same question on different websites may be significantly simplified. If the user would like to post the same question on different websites, he or she may post the question on only one website and the website then automatically forwards the question to the user designated websites through the APIs. Therefore, the user does not need to repeat the same posting operation on different websites as usual. In other words, the service provider not only can create (or receive) the questions issued by its own users, but also the question from other websites. Then, the questions received at the service provider may be retrieved by other websites by APIs (e.g., including operation instruction relating to get the questions). The other websites may answer these questions on their websites or return the answer to the service provider by APIs (e.g., including operation instruction relating to create the answers).

Currently, if a service provider would like to provide Q&A services, it needs to write or buy a program aimed at Q&A services and deploy it on its website. Then, different websites have their own program deployed thereon. It is thus a waste of time and resources to repeat the same program development and also it is hard to share contents among different websites.

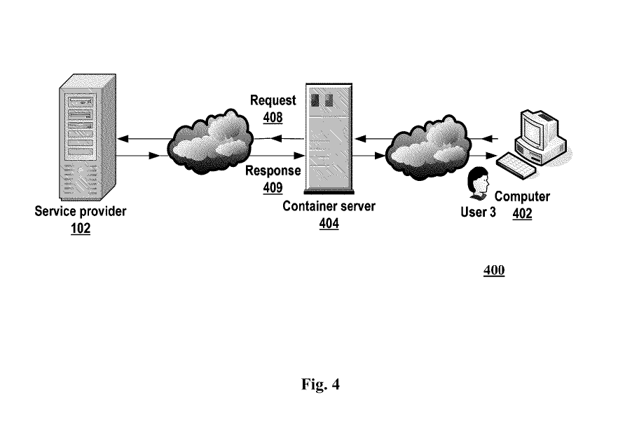

To improve the above defects, a gadget including APIs can be provided to the at least one website such that website appears to provide Q&A services on its own without writing complicated computer programs specific to or aimed at the services. This embodiment will be described later in detail in connection with FIG. 4.

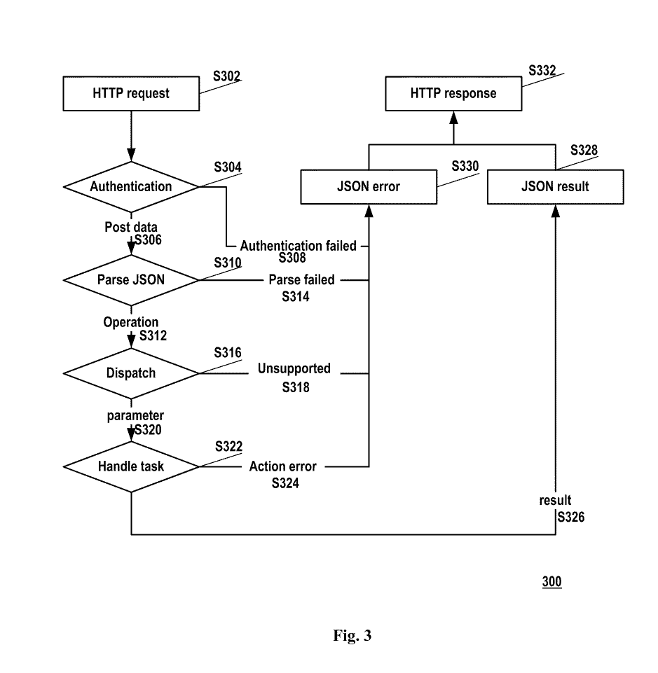

FIG. 3 is a flow diagram illustrating another method for providing Q&A services. As illustrated in FIG. 3, the method 300 receives a Hyper Text Transport Protocol (HTTP) request from at least one website at step S302. At step S304, the method 300 authenticates HTTP request, e.g., by 2-legged OAuth authentication. If the authentication at step S304 is successful, then the method 300 picks up the posted data contained in HTTP request at step S306 and then proceeds to step S310. At step S310, the method 300 use a JSON parser to parse the posted data to a JSON object. If the parsing is successful, that is, successfully extracting the posted data, then the method 300 sends the JSON object regarding various operation instructions at step S312. Then, at step S316, the method 300 dispatches JSON object to a special task according to, e.g., whether the item “method” in the API is supported or not. If it is supported, then at step S322, the method 300 handles the specified task. The Q&A server will modify the database and build index for the content. If the handling is successful, that is, successfully handle the specified method (herein refers to the item “method” not method 300), and then the method 300 puts the result which is a JSON object into HTTP response at step S332 and finally ends.

If the method 300 proceeds to step S308 or S314, this indicate that authentication and parse is failed. If the method 300 proceeds to step S318, this indicate that the item “method” in the API is not supported. If the method 300 proceeds to step S324, this indicates that an error occurs in the processing action. All these steps direct the method 300 to proceed to step S330. At step S330, the method 330 also puts the result which is a JSON object and indicates the specific error types (the forgoing four types) into HTTP response at step S332 and finally ends.

It should be understood that the steps of authentication, parse, and dispatches are commonly used technical means in the art to process the data.

FIG. 4 is a block diagram illustrating another method 400 for providing Q&A services. As illustrated in FIG. 4, suppose that a user 3 is using a computer to logon on a website (also called as container) which is provided with a gadget including APIs. When the user of the website would like to post a question on the network (e.g., Internet), he or she can input the question into a query field in the gadget on the website and thus a request 408 is formed simultaneously. Then the request 408 is sent over the network, as shown by dark cloud of right hand side, to the container server 404. At the container server 404, the request will be validated and added a signature. Then the container server forwards the request 408 to the service provider 102. At the service provider 102, the request will be processed as illustrated in FIG. 3. Finally, the JSON response 409 will be sent from the service provider 102 and forwarded to the computer of user 3 via the container server 404. The term “container” as used herein refers to such websites that contents are shared among users, such as social network websites. According to current specification regarding the gadget, information carried by the gadget must be forward via the contain server for secure reasons.

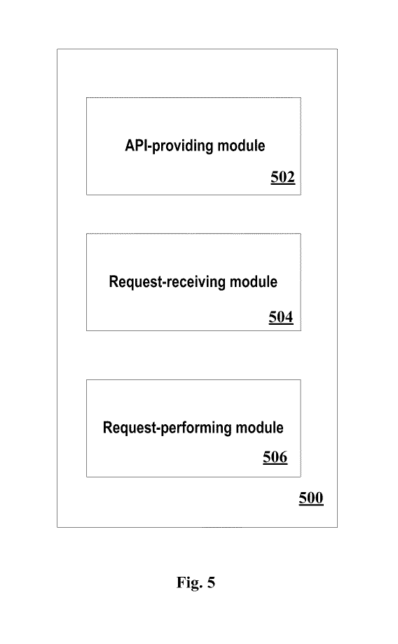

FIG. 5 is a block diagram of an apparatus for providing Q&A services. As illustrated in FIG. 5, an apparatus 500 comprise an API-providing module 502, a request-receiving module 504, and request-performing module 506. The API-providing module 504 provides, by a service provider, a plurality of APIs to at least one of a plurality of websites. The plurality of APIs include operation instructions regarding Q&A services. The request-receiving module 504 receives, at the service provider, a request from the at least one of the plurality of websites, to access Q&A services through at least one of APIs. The request-performing module 506 performs Q&A services requested by the at least one website.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, e.g., web services, distributed computing and grid computing infrastructures.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method implemented by data processing apparatus, the method comprising:
receiving a plurality of questions from a plurality of different servers according to a protocol that defines services for submitting questions and obtaining answers to questions;
for each received question, analyzing a textual form of the question and associating the question with one or more labels based on the analysis;
receiving a request from a server according to the protocol to obtain questions related to one or more first labels; and
identifying questions associated with one or more of the first labels and providing the identified questions in response to the request.

2. The method of claim 1 in which analyzing the textual form of the question and associating the question with one or more labels comprises using a concept graph to determine the labels based on words in the textual form of the question.

3. The method of claim 1 in which the protocol defines services for one or more of: creating, getting, searching, deleting, closing, labeling, forwarding, suggesting, classifying or rating a question.

4. The method of claim 1 in which the protocol defines services for one or more of: creating, labeling, rating, feeding, threading, getting or deleting an answer.

5. The method of claim 1 in which the protocol is defined in Extensible Markup Language.

6. The method of claim 1 in which the protocol is defined in Java Script Object Notation.

7. The method of claim 1 in which a first question in the plurality of questions was submitted by a user using an interactive gadget.

8. A system comprising:
a storage medium having stored instructions; and
data processing apparatus configured to execute the instructions to perform operations comprising:
receiving a plurality of questions from a plurality of different servers according to a protocol that defines services for submitting questions and obtaining answers to questions;
for each received question, analyzing a textual form of the question and associating the question with one or more labels based on the analysis;
receiving a request from a server according to the protocol to obtain questions related to one or more first labels; and
identifying questions associated with one or more of the first labels and providing the identified questions in response to the request.

9. The system of claim 8 in which analyzing the textual form of the question and associating the question with one or more labels comprises using a concept graph to determine the labels based on words in the textual form of the question.

10. The system of claim 8 in which the protocol defines services for one or more of: creating, getting, searching, deleting, closing, labeling, forwarding, suggesting, classifying or rating a question.

11. The system of claim 8 in which the protocol defines services for one or more of: creating, labeling, rating, feeding, threading, getting or deleting an answer.

12. The system of claim 8 in which the protocol is defined in Extensible Markup Language.

13. The system of claim 8 in which the protocol is defined in Java Script Object Notation.

14. The system of claim 8 in which a first question in the plurality of questions was submitted by a user using an interactive gadget.

15. A computer-readable medium including instructions that, when executed by data processing apparatus, perform operations comprising:
receiving a plurality of questions from a plurality of different servers according to a protocol that defines services for submitting questions and obtaining answers to questions;
for each received question, analyzing a textual form of the question and associating the question with one or more labels based on the analysis;
receiving a request from a server according to the protocol to obtain questions related to one or more first labels; and
identifying questions associated with one or more of the first labels and providing the identified questions in response to the request.

16. The medium of claim 15 in which analyzing the textual form of the question and associating the question with one or more labels comprises using a concept graph to determine the labels based on words in the textual form of the question.

17. The medium of claim 15 in which the protocol defines services for one or more of: creating, getting, searching, deleting, closing, labeling, forwarding, suggesting, classifying or rating a question.

18. The medium of claim 15 in which the protocol defines services for one or more of: creating, labeling, rating, feeding, threading, getting or deleting an answer.

19. The medium of claim 15 in which the protocol is defined in Extensible Markup Language.

20. The medium of claim 15 in which the protocol is defined in Java Script Object Notation.

21. The medium of claim 15 in which a first question in the plurality of questions was submitted by a user using an interactive gadget.
